(19) United States
(12) Patent Application Publication
(10) Pub. No.: US 2010/0084336 A1
(43) Pub. Date: Apr. 8, 2010

(54) Dechlorinating Chitosan Fibers and Method for Manufacturing the Same

(75) Inventors: Chang-Yei Lee, Tu-Chen City (TW); Jui-Sheng Lee, Tu-Chen City (TW); Su-Chen Chen, Tu-Chen City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TAIWAN TEXTILE RESEARCH INSTITUTE, Tu-Chen City (TW)

(21) Appl. No.: 12/344,948

(22) Filed: Dec. 29, 2008

(30) Foreign Application Priority Data
Oct. 2, 2008 (TW) 97137950

(51) Int. Cl. B01D 39/06; D01F 9/00

(52) U.S. Cl. 210/505; 264/186; 428/364; 428/401

(57) ABSTRACT

A method for manufacturing a dechlorinating chitosan fiber is provided. The method includes preparing a spinning solution and performing wet spinning with the spinning solution. The spinning solution is prepared by dispersing calcium sulfite and chitosan or derivates thereof in a solvent, wherein when the solvent is 100 parts by weight, the chitosan or derivates thereof is about 3-5 parts by weight and the calcium sulfite is about 3-5 parts by weight.

### RELATED APPLICATIONS

This application claims priority to Taiwan Application Serial Number 97137950, filed Oct. 02, 2008, which is herein incorporated by reference.

### BACKGROUND

1. Field of Invention

The present invention relates a dechlorinating fiber, particularly a dechlorinating chitosan fiber.

2. Description of Related Art

Currently the common processing measure for water purification includes removing the granules and impurities in the water, removing the organic matters in the water, removing the residual chlorine in the water, absorbing the heavy metals in the water, inhibiting bacterial activity, and softening water, etc.

There are numerous water purifying materials that are able to achieve one or part of said water purification effects. For example, activated carbon can be used to remove the organic matters, chlorine, trichloromethane, and some heavy metals in the water, but the activated carbon will become the hotbed for pathogens and bacterias after absorbing the organic matters, and thus the activated carbon need to be replaced periodically. Calcium sulfite is also a common material for water purification that can be used to remove the residual chlorine in the water. However, the hardness of the calcium sulfite particle made by the present technology is not high enough, which made it fragile and short-lived. Chitosan has the ability of heavy metal absorption, and it can be made in the form of fiber. Comparing with particles of calcium sulfite, chitosan is more suitable for industrial utilization.

However, the above-mentioned and other water purifying material have their respective limitation on the water purification efficiency and utilization.

Therefore, there is a need for presenting a new material for water purification, which is able to provide various water purification effects and better industrial utility.

### SUMMARY

Therefore, an aspect of the present invention is to provide a method for manufacturing a dechlorinating chitosan fiber. According to one embodiment of the present invention, the method comprises preparing a spinning solution, and performing wet spinning with the spinning solution. The spinning solution is prepared by dispersing calcium sulfite and chitosan or derivates thereof in a solvent, wherein when the solvent is 100 parts by weight, the chitosan or derivates thereof is about 3-5 parts by weight and the calcium sulfite is about 3-5 parts by weight.

According to one embodiment of the present invention, the dechlorinating chitosan fiber is made by wet spinning technique. The dechlorinating chitosan fiber comprises calcium sulfite and chitosan or derivates thereof, wherein the weight ratio of chitosan or derivates thereof to calcium sulfite used in manufacturing the dechlorinating chitosan fiber is about 5:1 to about 1:1.

Another aspect of the present invention is to provide a dechlorinating and water purifying material, wherein the dechlorinating and water purifying material comprises said dechlorinating chitosan fiber. According to yet other aspects of the present invention, the dechlorinating and water purifying material made from said dechlorinating chitosan fiber can be used in home-use or industry-use water purifier.

It is to be understood that both the foregoing general description and the following detailed description are by examples, and are intended to provide further explanation of the invention as claimed.

### DETAILED DESCRIPTION

These and other features, aspects, and advantages of the present invention will become better understood with reference to the following description and appended claims.

U.S. Pat. No. 5,897,821 disclosed a method for manufacturing chitosan into chitosan fibers by means of wet spinning. Because chitosan has antibacterial, heavy metal absorbing and many other capabilities, chitosan fibers are usually manufactured into a functional textile. However, dechlorinating capability of the chitosan fiber is limited, the main purpose of using chitosan fiber as the water purifying material is limited to heavy metal absorption.

Therefore, an aspect of the present invention is to provide a method for making dechlorinating chitosan fiber. According to the embodiment of the present invention, calcium sulfite is added in a spinning solution of chitosan or derivates thereof and is dispersed homogeneously in the solvent. Then wet spinning is performed to obtain a water purifying fiber with both dechlorinating and heavy metal absorbing capabilities.

However, during the process of making said dechlorinating chitosan fiber, it was found that when calcium sulfite was added in the spinning solution, a precipitation would be frequently occurred in the spinning solution and thus made the wet spinning inoperable, or the chitosan fiber made by wet spinning is brittle and hence unable for industrial application.

Therefore, according to one embodiment of the present invention, a method for manufacturing a dechlorinating chitosan fiber is provided. The method includes preparing a spinning solution and performing wet spinning with the spinning solution. The spinning solution is prepared by dispersing calcium sulfite and chitosan or derivates thereof in a solvent, wherein when the solvent is 100 parts by weight, the chitosan or derivates thereof is about 3-5 parts by weight and the calcium sulfite is about 3-5 parts by weight.

According to embodiments of the present invention, said chitosan derivates may be chitin or derivates thereof.

According to embodiments of the present invention, said calcium sulfite may be a calcium sulfite without water of crystallization.

The method and materials for making dechlorinating chitosan fiber according to the embodiments of the present invention will be described in detail below; and dechlorinating rates and heavy metal absorbing rates thereof will be analyzed and compared in a plurality of experiments and comparing examples.

### (1) The Method and Materials for Making Dechlorinating Chitosan Fiber

According to one embodiment of the present invention, the method for making dechlorinating chitosan fiber is as follows:

50g of chitosan and 50g of anhydrous calcium sulfite were added in 1000 g of about 3-5 wt % acetic acid solution to obtain a spinning solution;

the spinning solution was stirred with a homogenizer so that the spinning solution became a homogeneous dispersion;

the spinning solution was spinned by a wet spinning frame and molded in 5 wt % sodium hydroxide solution to obtain a fiber; and

the fiber was washed with water for several times until the fiber becomes neutral, and thus the dechlorinating chitosan fiber according to the present embodiment is obtained.

According to embodiments of the present invention, the dechlorinating chitosan fiber made by above-mentioned method comprises calcium sulfite and chitosan or derivates thereof, wherein the weight ratio of chitosan or derivates thereof to calcium sulfite used in manufacturing the dechlorinating chitosan fiber is about 5:1 to about 1:1. In addition, the diameter of said dechlorinating chitosan fiber is about 100-250 μm.

### (2) Addition Amount of Calcium Sulfite and Dechlorinating Efficiency of Dechlorinating Chitosan Fiber

In the following experiments of the present invention, dechlorinating chitosan fibers with different addition amount of calcium sulfite were manufactured according to the method described above. In addition, conventional chitosan fiber and calcium sulfite dechlorinating particle were took as comparing examples in order to compare the dechlorinating and water purification efficiency between the experiments described above and the comparing examples. The weight ratios of calcium sulfite used for making dechlorinating chitosan fiber in different experiments were listed in Table 1.

TABLE 1
Amount of calcium sulfite in each experiment

| | Amount of calcium | |
|---|---|---|
| Experiment | sulfite (g) | Note |
| A | 10 | |
| B | 30 | |
| C | 50 | |
| D | 100 | Fiber is brittle |

In this series of experiments, residual chlorine agent was used to test dechlorinating efficiency of the water purifying material in each experiment and comparing example. The principal component of the residual chlorine agent was 0.1 wt % o-tolidine hydrochloride solution. The test was conducted as follows: First, 50 μl of residual chlorine agent was added into water for reaction and color development. Then, spectral photometer was utilized to conduct measurement, wherein the absorbing wavelength was about 450 nm to quantitate the amount of residual chlorine in the water. After that, the water was passed through various water purifying materials described above, and the above-mentioned steps was repeated for quantitating the amount of residual chlorine in the water that was already passed through the water purifying materials described above.

In this series of experiments, the chlorine content in the water under room temperature (about 25° C.) was took as 100%, and the reduced amounts of the contents in other water samples passed through various water purifying materials were determined and the dechlorinating percentage of each water purifying material was calculated accordingly. The dechlorinating percentage of the water purifying material in each experiment and comparing example was listed in Table 2 to 5. It should be noted that the concentrations of chlorine ion in the water of each experiment listed in the following table were different due to the difference of sampling times, however the sample of each experiment and comparing example in the same table was sampled at the same time.

TABLE 2
the dechlorinating percentage of dechlorinating chitosan fiber of
experiment A

| | Cl | Dechlorinating |
|---|---|---|
| | concentration | percentage |
| Water | 6.3 ppm | 0% |
| Comparing example 1: | 1.5 ppm | 76% |
| conventional chitosan | | |
| fiber | | |
| Comparing example 2: | 2.1 ppm | 66% |
| dechlorinating pariticle | | |
| Experiment A: | 1.43 ppm | 77% |
| dechlorinating fiber | | |

TABLE 3
the dechlorinating percentage of dechlorinating chitosan fiber of
experiment B

| | Cl | Dechlorinating |
|---|---|---|
| | concentration | percentage |
| Water | 5.7 ppm | 0% |
| Comparing example 1: | 1.25 ppm | 78% |
| conventional chitosan | | |
| fiber | | |
| Comparing example 2: | 2.0 ppm | 65% |
| dechlorinating pariticle | | |
| Experiment B: | 0.9 ppm | 84% |
| dechlorinating fiber | | |

TABLE 4
the dechlorinating percentage of dechlorinating chitosan fiber of
experiment C

| | | Dechlorinating |
|---|---|---|
| | Cl concentration | percentage |
| Water | 3.3 ppm | 0% |
| Comparing example 1: | 0.825 ppm | 75% |
| conventional chitosan | | |
| fiber | | |
| Comparing example 2: | 1.05 ppm | 68% |
| dechlorinating pariticle | | |
| Experiment C: | 0.0098 ppm | 99% |
| dechlorinating fiber | | |

TABLE 5
the dechlorinating percentage of dechlorinating chitosan fiber of
experiment D

| | | Dechlorinating |
|---|---|---|
| | Cl concentration | percentage |
| Water | 6.3 ppm | 0% |
| Comparing example 1: | 1.5 ppm | 76% |
| conventional chitosan fiber | | |
| Comparing example 2: | 2.1 ppm | 66% |
| dechlorinating pariticle | | |
| Experiment D: | — | — |
| dechlorinating fiber | | |

As can be seen in table 2, in experiment A, the addition amount of calcium sulfite to the solvent was about 1%, whereby the resulting dechlorinating efficiency of chitosan fiber that contains calcium sulfite was about 77%, which was about the same with the dechlorinating efficiency of conventional chitosan fiber (about 76%). That is to say, the chitosan fiber with this addition amount of calcium sulfite may not be provided with additional dechlorinating ability.

On the other hand, it can be found that when the addition amount of calcium sulfite to the solvent was about 10% (experiment D), the physical property of the chitosan fiber may be affected by the excess addition amount of the calcium sulfite, thus there was large amount of precipitation occurred in the obtained spinning solution during the manufacturing process. Therefore, a homogeneous dispersion was difficult to obtain. Even if the wet spinning process was carried out, the obtained chitosan fiber containing calcium sulfite was very brittle, which was therefore unsuitable for industrial application.

From the series of experiments described above, it can be found that only when the addition amount of calcium sulfite to the solvent was about was about 3-5%, the obtained fiber would be provided with well dechlorinating ability and industry utility.

### (3) Heavy Metal Absorbing Capability of Dechlorinating Chitosan Fiber

Chitosan fiber itself has heavy metal absorbing capability. In the following experiments, the heavy metal absorbing capability of the dechlorinating chitosan fiber of experiment C and chitosan fiber of comparing example 1 was tested in accordance with ICP-AES standard so as to confirm whether the heavy metal absorbing capability of dechlorinating chitosan fiber made according to the embodiments of the present invention was jeopardized. The heavy metal tested included manganese (Mn), cadmium (Cd), cobalt (Co) and nickel (Ni). The results were listed in Table 6.

TABLE 6
Results of heavy metal absorbing experiments

| | | Heavy metal type | | | |
|---|---|---|---|---|---|
| | | Mn | Cd | Co | Ni |
| Experiment C: | Original | 9850 | 10050 | 14050 | 7700 |
| Dechlorinating | concentration | | | | |
| chitosan | (ppm) | | | | |
| fiber | Risidual | 2500 | 1400 | 2352 | 520 |
| | concentration | | | | |
| | (ppm) | | | | |
| | Risidual rate (%) | 25.4 | 13.9 | 16.7 | 6.75 |
| | Absorbing rate | 74.6 | 86.1 | 83.3 | 93.25 |
| | (%) | | | | |
| Comparing | Original | 9850 | 10050 | 14050 | 7700 |
| example 1: | concentration | | | | |
| Conventional | (ppm) | | | | |
| chitosan | Risidual | 2756 | 1852 | 3264 | 459 |
| fiber | concentration | | | | |
| | (ppm) | | | | |
| | Risidual rate (%) | 28 | 18.4 | 23.2 | 6 |
| | Absorbing rate | 72 | 81.6 | 76.8 | 94 |
| | (%) | | | | |

From this series of experiments, it can be found that the dechlorinating chitosan fiber of experiment C had better absorbing capabilities with regard to Mn, Ni and Co as comparing with the conventional chitosan fiber. The absorbing capabilities of both chitosan fibers with regard to Ni were about the same. Therefore, the dechlorinating chitosan fiber manufactured according to the method of the embodiments of the present invention can preserve the heavy metal absorbing capability and exhibit well dechlorinating ability at the same time.

The residual concentrations of calcium ion and magnesium ion in water are considered important for home-use water. When conventional calcium sulfite chlorinating particle was used as a water purifying material, one of the problems is the raise of calcium ion concentration in the water. Therefore, the residual concentrations of calcium ion and magnesium ion in the water that passed through the water purifying materials of comparing example 1, comparing example2 and experiment C were tested in accordance with ICP-AES standard as well. The results were listed in Table 7.

TABLE 7
Test result of the residual concentrations of calcium ion and
magnesium ion

| | Ca (ppm) | Mg (ppm) |
|---|---|---|
| Blank | 27.5 | 7.3 |
| Comparing example 1: conventional | 42.3 | 7.1 |
| chitosan fiber | | |
| Comparing example 2: dechlorinating particle | 49.7 | 6.9 |
| Example C: dechlorinating chitosan fiber | 40.0 | 7.7 |

It can be found from Table 7 that the concentration of calcium ion was about 27.5 ppm, which was up to 49.7 ppm while the conventional calcium sulfite dechlorinating particle was used as the water purifying material in comparing example 2. On the other hand, the concentration of calcium ion was 40.0 ppm while the dechlorinating chitosan fiber was used as the water purifying material in experiment C.

It can be understood from above illustrations that the dechlorinating chitosan fiber according to the experiments of the present invention has not only heavy metal absorbing capability but also well dechlorinating ability. Moreover, the above-mentioned dechlorinating chitosan fiber has a wide variety of industrial utility and can be made into various water purifying materials, therefore the applications in people's living is much wider than conventional dechlorinating particle.

According to another aspect of the present invention, the dechlorinating chitosan fiber can be used as a dechlorinating and water purifying material. And since the surface area of the fiber is larger than that of the convention particles, a small quantity of calcium sulfite is enough to provide the dechlorinating ability comparable to that of calcium sulfite dechlorinating particles. Accordingly, since the amount of calcium sulfite used is lower, the residual calcium concentration of the treated water is lower.

According to another aspect of the present invention, a dechlorinating and water purifying material made from the above-mentioned dechlorinating chitosan fiber can be used in home-use water filter or industry-use water filter. Since the dechlorinating and water purifying material according to embodiments of the present invention is manufactured in the form of fibers, this dechlorinating and water purifying material has not only the heavy metal absorbing and dechlorinating capability but also physical filterability. For example, a filter screen can be produced from the dechlorinating chitosan fiber according to the embodiments of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for manufacturing a dechlorinating chitosan fiber, comprising:
(a) preparing a spinning solution by dispersing chitosan or derivates thereof in a solvent, wherein when the solvent is 100 parts by weight, the chitosan or derivatives thereof is about 3-5 parts by weight;
(b) adding calcium sulfite into the spinning solution, wherein the calcium sulfite is about 3-5 parts by weight; and
(c) spinning the spinning solution obtained by step (b) with a wet spinning frame.

2. The method of claim 1, wherein the derivates of chitosan is chitin or derivates thereof.

3. The method of claim 1, wherein the calcium sulfite is calcium sulfite without water of crystallization.

4. The method of claim 1, wherein the solvent is 3-5 wt % acetic solution.

5. The method of claim 1, wherein the step (c) further comprises utilizing an about 5 wt % sodium hydroxide solution to mold the dechlorinating chitosan fiber.

6. An dechlorinating chitosan fiber made by wet spinning technology, comprising:
calcium sulfite; and
chitosan or derivates thereof, wherein the weight ratio of chitosan or derivates thereof to calcium sulfite is about 5:1 to about 1:1.

7. The dechlorinating chitosan fiber of claim 6, wherein the diameter of the dechlorinating chitosan fiber is about 100 μm to 250 μm.

8. The dechlorinating chitosan fiber of claim 6, wherein the derivates of chitosan is chitin or derivates thereof.

9. A dechlorinating and water purifying material, comprising dechlorinating chitosan fiber of claim 6.

10. The dechlorinating and water purifying material of claim 9, wherein the dechlorinating and water purifying material is a home-use water filter.

11. The dechlorinating and water purifying material of claim 9, wherein the dechlorinating and water purifying material is an industry-use water filter.
